(19) United States
(12) Patent Application Publication
(10) Pub. No.: US 2025/0271015 A1
(43) Pub. Date: Aug. 28, 2025

(54) CONNECTING DEVICE, INSTALLATION DEVICE, AND SYSTEM FOR RESPECTIVELY CONNECTING A FIRST COMPONENT AND A SECOND COMPONENT

(71) Applicant: Lamello AG, Bubendorf (CH)

(72) Inventor: Patrick JEKER, Brislach (CH)

(73) Assignee: Lamello AG, Bubendorf (CH)

(21) Appl. No.: 19/204,800

(22) Filed: May 12, 2025

Related U.S. Application Data
(63) Continuation of application No. PCT/EP2023/081017, filed on Nov. 7, 2023.

(30) Foreign Application Priority Data
Nov. 14, 2022 (DE) 10 2022 130 057.9

(51) Int. Cl. F16B 12/44

(52) U.S. Cl. CPC F16B 12/44

(57) ABSTRACT

A connecting device for connecting a first component and a second component, comprising: a first connecting element arranged on the first component in the connected state of the components; and/or a second connecting element arranged on the second component in the connected state of the components, wherein the first connecting element comprises a first housing and a holding element, which is movable relative to the first housing of the first connecting element, for releasably connecting the first connecting element to the second connecting element and/or to the second component, wherein the movable holding element comprises a first holding contour, wherein the second connecting element and/or the second component comprises a second holding contour behind which the first holding contour is able to engage, wherein at least one of the connecting elements comprises, on the respective housing, a curved face, which is in the form of a circular arc in longitudinal section.

### RELATED APPLICATION

This application is a continuation of international application No. PCT/EP2023/081017 filed on Nov. 7, 2023, and claims the benefit of German application No. 10 2022 130 057.9 filed on Nov. 14, 2022, which are incorporated herein by reference in their entirety and for all purposes.

### FIELD OF DISCLOSURE

The present invention relates to a connecting device for connecting a first component and a second component, in particular for connecting furniture or machine parts.

Furthermore, the present invention relates to an installation device for a connecting device for connecting a first component and a second component, in particular for connecting furniture or machine parts.

Moreover, the present invention relates to a system for connecting a first component and a second component, in particular for connecting furniture or machine parts.

### BACKGROUND

Such connecting devices for connecting a first component and a second component are known in principle from the prior art. Such connecting devices may, for example, comprise at least one connecting element which comprises a curved contact face which is in the form of a circular arc in longitudinal section and on the edge of which a holding protrusion is provided, along which the connecting element is pivotable into the component to be connected and by means of which the connecting element can be held in this component. In particular for such connecting devices, and for connecting devices of a comparable type in general, a certain minimum thickness is required of the components to be connected, in order to avoid damage to the components and to ensure or allow reliable connection of the components. In particular in the case of thin components to be connected, the risk of these components being damaged during the connecting process is high or it is not technically possible to realize a connection with such connecting devices, or this is only possible in a very complicated manner.

Therefore, the present invention addresses the problem of solving the abovementioned problems, in particular of creating a connecting device of the type mentioned at the beginning, which allows two in particular thin components to be connected releasably in a secure and/or reliable manner.

### SUMMARY OF THE INVENTION

This problem is solved according to the invention by the features of claim 1. Advantageous developments of the invention are described in the dependent claims.

The connecting device according to the invention for connecting a first component and a second component, in particular for connecting furniture or machine parts, comprises:
a first connecting element arranged on the first component in the connected state of the components; and/or
a second connecting element arranged on the second component in the connected state of the components,
wherein the first connecting element comprises a first housing and a holding element, which is movable relative to the first housing of the first connecting element, for releasably connecting the first connecting element to the second connecting element and/or to the second component,
wherein the movable holding element comprises a first holding contour,
wherein the second connecting element and/or the second component comprises a second holding contour behind which the first holding contour is able to engage,
   wherein at least one of the connecting elements comprises, on the respective housing, a curved face, which is in the form of a circular arc in longitudinal section, and a substantially planar access face, which is located opposite this curved face and faces the other connecting element in the connected state of the components,
wherein at least one of the connecting elements extends in a thickness direction and in a longitudinal direction, wherein the thickness direction is oriented substantially perpendicularly to a connecting direction which is directed transversely, preferably substantially perpendicularly, to the access face, and wherein the longitudinal direction is oriented substantially perpendicularly to the thickness direction and substantially parallel to or coincident with the substantially planar access face.

Provision may be made for the connecting direction to be a direction along which a relative movement of the first connecting element and of the second connecting element and/or of the second component is prevented when the first holding contour engages behind the second holding contour.

The connecting direction may define a depthwise direction with regard to the respective connecting elements, along which a depthwise extent of the respective connecting elements can extend.

Provision may be made for the at least one of the connecting elements to be precisely the first connecting element, or for that least one of the connecting elements to be precisely the second connecting element, or for the at least one of the connecting elements to comprise precisely the first and the second connecting element, i.e. both of them.

Provision may be made for a ratio between the extent in the thickness direction and the extent in the longitudinal direction of at least one of the connecting elements to be less than or equal to 1 to 9, in particular less than or equal to 1 to 10, preferably less than or equal to 1 to 11.

For example, the ratio between the extent in the thickness direction and the extent in the longitudinal direction may be between 1 to 9 and 1 to 25, in particular between 1 to 10 and 1 to 25, preferably between 1 to 11 and 1 to 25. It should be understood that the abovementioned ratio values can be considered as corresponding to “less than” or “less than or equal to” and/or “greater than” or “greater than or equal to”.

The ratio between the extent in the thickness direction and the extent in the longitudinal direction may be, for example, substantially 1 to 15.

Additionally or alternatively, provision may be made for the extent in the thickness direction to be less than 8 mm, in particular less than 7 mm, preferably less than 6 mm, for example less than 5 mm. The extent in the thickness direction may be, for example, substantially 4 mm±10%, in particular ±5%. Other extents in the thickness direction may be conceivable, for example substantially 5 mm, 6 mm or 7 mm, in each case ±10%, in particular in each case ±5%.

Provision may be made for the second connecting element to comprise a second housing. The second holding contour may be arranged in particular on or in the second housing.

Provision may be made for that at least one of the connecting elements to have a chamber which is arranged in the respective housing and which opens out at a mouth opening in the access face and extends, on the opposite side, into the curved face, wherein, on a side wall of the chamber, at least one reinforcing portion is provided, which reduces an extent of the chamber, with regard to the thickness direction, toward the curved face.

The at least one reinforcing portion may be formed, for example, substantially in a stepped or continuously enlarging, in particular substantially wedge-shaped, manner.

Provision may be made for the at least one reinforcing portion to comprise a first and a second reinforcing portion, which are respectively provided on mutually opposite sides of the side wall of the chamber.

Provision may be made for the respective holding contour to be arranged in the chamber of the particular connecting element.

In particular, provision may be made, in the case of the first connecting element, for the chamber to serve to receive the holding element. In other words, the chamber may be a receiving chamber. The holding element may be movable, in particular reversibly, out of the chamber through the mouth opening, in particular in order to be able to be brought into engagement with the second holding contour.

Provision may be made for at least one of the connecting elements to have at least one notch which extends from the access face in the direction of the curved face such that the particular connecting element also has a counter face that is recessed with respect to the access face, wherein a through-hole in particular in the form of an oblong hole is provided in the counter face, said through-hole extending into the curved face and serving to receive an anchoring element for securing the particular connecting element to a groove bottom of a groove provided in one of the components, wherein, in particular, a longitudinal axis of the through-hole extends substantially in a radial direction of the curved face.

In other words, provision may be made for at least one of the connecting elements to have at least one fastening portion which is set back in the direction of the curved face with regard to the access face and which has a counter face that is set back with respect to the access face, wherein a through-hole in particular in the form of an oblong hole is provided in the counter face, said through-hole extending into the curved face and serving to receive an anchoring element for securing the particular connecting element to a groove bottom of a groove provided in one of the components, wherein, in particular, a longitudinal axis of the through-hole extends substantially in a radial direction of the curved face.

Provision may be made for the through-hole to narrow from the curved face in the direction of the counter face, in particular with regard to the longitudinal direction, preferably substantially only with regard to the longitudinal direction.

In particular, provision may be made for the longitudinal axis of the through-hole to be arranged at an angle of between 10° and 25°, in particular between 15° and 20°, preferably substantially 18°, with respect to the connecting direction.

Additionally or alternatively, provision may be made for at least one of the connecting elements to have a first and a second notch which are respectively arranged, with regard to the longitudinal direction, at or near a respectively opposite end of the particular connecting element and which respectively extend from the access face in the direction of the curved face such that the particular connecting element also has a first and a second counter face which are respectively recessed with respect to the access face, wherein a through-hole in particular in the form of an oblong hole is provided in each of the counter faces, said through-hole respectively extending into the curved face and respectively serving to receive an anchoring element for securing the particular connecting element to a groove bottom of a groove provided in one of the components, wherein, in particular, a longitudinal axis of the respective through-hole extends substantially in a radial direction of the curved face.

In other words, provision may be made for at least one of the connecting elements to have a first and a second fastening portion which are respectively arranged, with regard to the longitudinal direction, at or near a respectively opposite end of the particular connecting element and which are set back in the direction of the curved face with regard to the access face, wherein the first and the second fastening portion are correspondingly assigned a first and a second counter face, these respectively being set back with respect to the access face, wherein a through-hole in particular in the form of an oblong hole is provided in each of the counter faces, said through-hole respectively extending into the curved face and respectively serving to receive an anchoring element for securing the particular connecting element to a groove bottom of a groove provided in one of the components, wherein, in particular, a longitudinal axis of the respective through-hole extends substantially in a radial direction of the curved face.

Provision may be made for the respective through-holes to narrow from the curved face in the direction of the counter face, in particular with regard to the longitudinal direction, preferably substantially only with regard to the longitudinal direction.

In particular, provision may be made for the respective longitudinal axes of the through-holes to be arranged at an angle of between 10° and 25°, in particular between 15° and 20°, preferably substantially 18°, with respect to the connecting direction. Consequently, the arrangement of the respective longitudinal axes of the through-holes to one another may be designed with an angle value that is respectively correspondingly twice as high.

Provision may be made for the particular connecting element to be provided or able to be provided, in each through-hole, with an anchoring element, in particular in the form of an anchoring screw, for securing the particular connecting element to one of the components.

Preferably, the respective anchoring element for securing the particular connecting element to the groove bottom of the groove provided in one of the components may be provided with an angular orientation depending on the corresponding angular orientation of the longitudinal axis of the through-holes.

Additionally or alternatively, the anchoring element may be in the form of an anchoring nail. In other words, an anchoring element may be an anchoring screw or an anchoring nail, wherein, for example, two anchoring elements may comprise an anchoring screw and an anchoring nail, or be of the same type. It should be understood that the anchoring element may be formed in an alternative way suitable for an intended use, for example as a pin and/or as a rivet. Furthermore, it should be understood that the connecting device, in particular the first and/or the second connecting element, may be able to be fastened in the first and/or the second component by means of an additional or alternative anchoring means, for example by means of an adhesive, for example a glue.

Provision may be made for the respective counter face to be recessed or set back with regard to the access face such that, when the anchoring element in the through-hole bears against the counter face, a head of the anchoring element does not project beyond the access surface with regard to the connecting direction and/or is arranged in particular below a plane defined by the access face.

Additionally or alternatively, provision may be made that, when the anchoring element in the through-hole bears against the counter face, a or the head of the anchoring element does not project (with regard to the thickness direction) beyond a, in particular each, lateral edge, with regard to the thickness direction, of the counter face.

In other words, the anchoring element may be able to be arranged on the particular connecting element such that its head does not protrude with regard to side walls of the particular connecting element with regard to the thickness direction and the access face of the particular connecting element, or is arranged in particular within these limits. In particular, the particular connecting element may be configured in such a way.

It should also be understood that a head of the anchoring element may be in particular a screw head or a nail head (depending on the type of anchoring element).

Provision may be made for the housing of at least one of the connecting elements to have a portion that narrows with regard to the thickness direction, said portion being arranged, in the connecting direction, on a side of the housing that faces away from the access face, and serving for the targeted insertion of the particular connecting element into a groove which is provided in the component that is able to be assigned to the connecting element, wherein, in particular, this narrowing with regard to the connecting direction is between 5° and 15°, in particular between 7.5° and 12.5°, preferably substantially 10°.

In particular, provision may be made for the at least one reinforcing portion which is provided in the chamber of the particular connecting element to extend at least partially in a manner corresponding to the narrowing portion from the side of the housing that faces away from the access face, in particular with regard to the connecting direction, and preferably to have an at least identical extent to or greater extent than the narrowing portion in the connecting direction. In particular, by means of this at least partially corresponding arrangement, an in particular substantially constant wall thickness of a side wall of the respective housing may be able to be ensured, or a reduction in the wall thickness of a side wall of the respective housing may be at least able to be reduced or minimized in each case with regard to the thickness direction.

Provision may be made for one or more in particular substantially conical or substantially pyramid-shaped protrusions to be provided on the curved face, said protrusions protruding from the curved face in a direction away from the latter.

In particular, the protrusions may be arranged next to the through-holes. For example, with regard to the longitudinal direction, at least one protrusion may be arranged on one or on each side of each of the through-holes.

The one or more protrusions may serve to at least partially penetrate into a or the component to be connected, in order to be able to act in particular as anti-slip means when the particular connecting element is anchored by means of an anchoring element.

Such a protrusion may be in the form, in particular, of an in particular sharp spike.

Provision may be made for at least one of the connecting elements to have one or more ribs which are provided on a side wall of the respective housing, said side wall extending transversely to the curved face of the particular connecting element, wherein the one or more ribs on the side wall extend along the connecting direction and protrude toward the access face from the side wall in an in particular continuously enlarging manner with regard to the thickness direction.

Provision may be made for one or more ribs to be provided on opposite sides on a or the respective side wall of the respective housing.

The ribs may be arranged substantially uniformly, in particular at a uniform spacing from one another, on the respective side wall.

One or more, in particular all, of the ribs may have an extent that narrows with regard to the longitudinal direction, wherein the extent relates per se to a direction from the access face to the curved face.

Provision may be made for one of the connecting elements to have at least one supporting element and the other of the connecting elements to have at least one mating element that is formed in an at least partially complementary manner thereto, these being engaged with one another in the connected state of the components, wherein the at least one supporting element is arranged on the access face of the one connecting element and forms a part of a side wall of the housing of the one connecting element, wherein, optionally, the at least one supporting element is in the form of a supporting protrusion and the associated mating element is in the form of a supporting recess and/or supporting-element receptacle, wherein, in particular, the at least one supporting element has a substantially convex shape starting from the access face.

The at least one supporting element may be precisely one supporting element, which is arranged substantially centrally on the particular access face in particular with regard to the longitudinal direction.

Additionally or alternatively, the at least one supporting element may comprise a first and a second supporting part-element, which are assigned to opposite side walls of the housing with regard to the thickness direction and are, in particular, spaced apart from one another by means of the mouth opening of the respective chamber.

It is also conceivable for the at least one supporting element to be able to comprise precisely two or more supporting elements, which, for example, may in turn respectively comprise a first and a second supporting part-element, as described above.

Provision may preferably be made for the first connecting element to be provided with the at least one supporting element and for the second connecting element to be provided with the at least one corresponding mating element.

Provision may be made for at least one of the connecting elements to comprise at least one plug-in protrusion and the respectively other connecting element to comprise at least one receiving pocket that receives the plug-in protrusion in the connected state of the components. As a result, it is possible, for example, by means of the connection between the connecting elements, for shear forces to be removed and/or it is possible to dispense with additional plugs, as may be necessary in most other connecting devices.

The at least one plug-in protrusion may be provided laterally with a plurality of ribs and/or grooves, which extend substantially along the connecting direction, wherein the at least one receiving pocket may be provided laterally with a plurality of grooves and/or ribs corresponding to the plurality of ribs and/or grooves of the at least one plug-in protrusion, in order to be able to be brought into mutual engagement with one another and to be (brought) in (to) mutual engagement in particular in the connected state of the components.

Provision may be made for each plug-in protrusion and/or each receiving pocket of the respective connecting elements to be correspondingly assigned at least one rib on the side wall of the respective housing of the particular connecting element and in particular to be oriented in a correspondingly aligned manner along the connecting direction.

Provision may be made for the holding element to be movable from a holding position into a release position and/or from the release position into the holding position by means of a mechanical actuating device that is able to be brought into engagement with the holding element from outside the connecting element, wherein, in the holding position, the first holding contour at least partially engages behind the second holding contour, and in the release position, the first holding contour does not engage behind the second holding contour.

Provision may be made for the housing of the first connecting element to be provided with a passage opening for the passage of a mechanical actuating device to the holding element.

In other words, in order to allow the mechanical actuating device to act on the holding element, provision may be made for the housing of the first connecting element to comprise a passage opening for the passage of the mechanical actuating device to the holding element.

In particular, the mechanical actuating device may have a polygonal key, a hex key and/or a screwdriver.

Preferably, the connection of the two connecting elements may be brought about or able to be brought about by a relative movement of the holding element from the release position into the holding position relative to the housing of the first connecting element. Furthermore, it is preferably possible for the connection between the connecting elements to be releasable and/or released by a movement of the holding element from the holding position into the release position relative to the housing of the first connecting element.

Preferably, the connecting elements may be lockable and/or locked together by the movement of the holding element into the holding position, such that, as a result of tensile forces that act on the connecting elements in the connecting direction, the components to be connected are braced and/or able to be braced with one another, with the result that a completely firm connection between the components to be connected is established and/or able to be established.

Provision may be made for at least one of the connecting elements to be insertable substantially along the connecting direction into a groove which is provided in the component that is able to be assigned to the connecting element.

Additionally or alternatively, the at least one of the connecting elements may be insertable substantially purely translationally into the groove, such that, in particular, no pivoting in about any axis and/or along any curved face is necessary.

Furthermore, the present invention provides an installation device for a connecting device for connecting a first component and a second component, in particular for connecting furniture or machine parts.

In particular, this connecting device may be the connecting device that is configured as described above and/or below.

The installation device according to the invention comprises:
a main body, which extends substantially along a central axis,
wherein the main body is formed at least partially in a complementary and/or corresponding manner to the connecting device in order to be able to be brought into in particular form- and/or force-fitting engagement therewith and/or to be insertable into a groove which is provided in one of the components to be connected for the at least partial insertion of the connecting device.

In particular, by means of this installation device, it may be possible for at least one processing step to be able to be carried out by means of the installation device on one of the components to be connected in preparation for installation of the connecting device therein, and/or for the connecting device itself to be able to be at least partially installed by means of the installation device in at least one of the components to be connected.

Provision may be made for the main body to have a first and a second portion, wherein the first portion is formed at least partially in a complementary manner to a first part of the connecting device in order to be able to be brought into in particular form-and/or force-fitting engagement with this part, and wherein the second portion is formed at least partially in a corresponding manner to a second part of the connecting device in order to be insertable into a groove which is provided in one of the components to be connected for the at least partial insertion of the connecting device, in particular for the substantially complete insertion of the second part of the connecting device.

Preferably, the first part and/or the second part of the connecting device may be assigned to one or more portions of the first and/or the second connecting element.

Provision may be made for the first portion to be arranged at a first end of the main body with regard to the central axis and to be formed at least partially in a complementary manner to a side of the at least one of the connecting elements of the connecting device, said side being faced by the access face of the particular connecting element of the connecting device.

Provision may be made for the first portion to have at least one protrusion which protrudes substantially in the direction of the central axis and which is able to be brought into in particular form-and/or force-fitting engagement with at least one of the connecting elements of the connecting device, in particular with a or the through-hole in particular in the form of an oblong hole which is provided in the particular connecting element of the connecting device.

In particular, the first portion may have a first and a second protrusion, wherein the first protrusion is able to be brought into in particular form-and/or force-fitting engagement with a first through-hole in particular in the form of an oblong hole which is provided in the particular connecting element of the connecting device, and wherein the second protrusion is able to be brought into in particular form-and/or force-fitting engagement with a second through-hole in particular in the form of an oblong hole which is provided in the particular connecting element of the connecting device.

Preferably, the first through-hole may be the through-hole provided in the first counter face, and the second through-hole may be the through-hole provided in the second counter face.

Provision may be made for the first portion to have at least one notch in which at least one plug-in protrusion of one of the connecting elements of the connecting device is able to be received, in particular when the installation device is engaged with the connecting device, preferably by means of the at least one protrusion of the first portion.

In particular, when there are two plug-in protrusions, the first portion may have a first and a second notch for the respectively associated reception of a plug-in protrusion.

Optionally, the first portion may have at least one further notch, in which at least one supporting element of one of the connecting elements of the connecting device is able to be received, in particular when the installation device is engaged with the connecting device, preferably by means of the at least one protrusion of the first portion.

Provision may be made for the second portion to extend substantially perpendicularly to the central axis and to have a curved face which is in the form of a circular arc in longitudinal section and faces away from the main body, wherein in particular the second portion is formed in a manner substantially corresponding to at least one of the connecting elements of the connecting device and preferably the second portion has a ratio between an extent in the direction of the central axis and an extent perpendicular thereto along the main body of less than or equal to 1 to 9, in particular less than or equal to 1 to 10, preferably less than or equal to 1 to 11.

For example, this ratio may be between 1 to 9 and 1 to 25, in particular between 1 to 10 and 1 to 25, preferably between 1 to 11 and 1 to 25. It should be understood that the abovementioned ratio values can be considered as corresponding to “less than” or “less than or equal to” and/or “greater than” or “greater than or equal to”.

The ratio may be, for example, substantially 1 to 15.

Additionally or alternatively, provision may be made for the extent of the second portion in the direction of the central axis to be less than 8 mm, in particular less than 7 mm, preferably less than 6 mm, for example less than 5 mm. The extent may be, for example, substantially 4 mm±10%, in particular ±5%.

The second portion may have, in the direction of the central axis, a first, in particular upper side wall and an opposite second, in particular lower side wall.

Provision may be made for the side walls each to be provided with one or more ribs, in particular compression ribs, which protrude substantially in the direction of the central axis from the respective side wall. Preferably, a thickness tolerance and/or a thickness difference of the groove into which the installation device is at least partially insertable and which is provided in one of the components to be connected for the at least partial insertion of the connecting device may be able to be compensated by means of the ribs when the installation device has been partially inserted into the groove.

Provision may be made for the second portion to have an in particular circular notch or a through-bore, which is open at least in that side wall of the second portion that faces away from the first portion. In the case of a through-bore, this may extend continuously from the first side wall to the second.

Preferably, the second portion may correspond substantially to an external contour of the housing of the first connecting element of the connecting device and/or to the external contour of the housing of the second connecting element of the connecting device.

In particular, the in particular circular notch or the through-bore in the second portion may be arranged in a manner corresponding to the passage opening in the housing of the first connecting element, said passage opening serving for the passage of the mechanical actuating device to the holding element.

In other words, the second portion may correspond substantially to an external contour of the housing of the first connecting element of the connecting device and/or to the external contour of the housing of the second connecting element of the connecting device, wherein the external contour of the housing of the first connecting element comprises a contour of the passage opening.

Provision may be made for the main body to have at least one substantially planar stop face for placing in a substantially flush manner against one of the components to be connected, from which the second portion extends substantially perpendicularly to the central axis.

Optionally, at least one recess may be arranged in the at least one stop face, and this recess may serve in particular to receive material, for example chips, separated by means of a machining step, for example boring, out of one of the components to be connected.

In particular, the at least one recess may extend from the stop face in the direction of a side of the main body that faces away from the second portion and in particular may pass in particular fully through the main body substantially in this direction.

Provision may be made for the main body to have a third portion in which a through-bore for receiving and/or passing through a boring tool is provided, wherein the through-bore extends in the direction of the central axis and/or substantially perpendicularly to the second portion, and the one mouth opening thereof faces the second portion, wherein at least one boring bush is optionally arranged or able to be arranged in the through-opening.

Preferably, provision may be made for the through-bore in the third portion and the in particular circular notch or the through-bore in the second portion to have a common axis, which is oriented in particular substantially parallel to the central axis.

The in particular circular notch or the through-bore in the second portion may be configured to at least partially receive the boring tool.

Preferably, the common axis of the through-bore in the third portion and of the in particular circular notch or the through-bore in the second portion may be arranged at a defined position with regard to a component to be connected, when the second portion of the installation device has been inserted into the groove which is provided in the components to be connected for the at least partial insertion of the connecting device, wherein, when the first connecting element of the connecting device has been inserted substantially completely into this groove, a longitudinal axis of the passage opening for the passage of the mechanical actuating device to the holding element is arranged at this defined position with regard to the particular component.

In other words, by means of the boring tool in conjunction with the installation direction, a bore may be able to be created in a component to be connected, said bore being arranged and/or able to be arranged at that position that substantially corresponds to that position at which the passage opening in the first connecting element is correspondingly arranged when the first connecting element has been inserted into said groove.

Optionally, the third portion may be provided with a stop face which faces away from the main body in the direction of the central axis and serves for the abutment of a depth stop which may be attached to the boring tool for defined boring into a component to be connected.

Additionally or alternatively, the third portion may be provided with a substantially planar face which is oblique with respect to the central axis, faces the second portion and in particular encloses an angle with the substantially planar stop face. The angle may be, for example, 45°. Other angle values may likewise be conceivable, for example 15°, 30°, 60° or 75°.

Provision may be made for the first portion to be arranged at a first end of the main body and the third portion to be arranged at a second end of the main body with regard to the central axis, wherein in particular the second portion is arranged between the first and the third portion with regard to the central axis.

It may be conceivable for the main body to have at least one pulse receiving face which is arranged in particular between the third and the second portion and serves to receive pulses, for example hammer strikes, in order to achieve orientation of the installation device in conjunction with a component to be connected and/or to allow and/or force insertion of a connecting element coupled to the installation device into a component to be connected.

The at least one pulse receiving face may preferably be oriented at least partially or substantially entirely in the direction of the central axis. The at least one pulse receiving face may have a surface portion to which the central axis is substantially perpendicular, and may have a further surface portion which is at an angle to the first surface portion. The angle may be, for example, 45°. Other angle values may likewise be conceivable, for example 15°, 30°, 60° or 75°.

Optionally, the main body may have a center marker which indicates a central mirror plane of the main body and which is arranged in particular on the first portion.

Preferably, after the groove has been introduced into the component to be connected, the second portion of the installation device may be inserted into this groove and a hole may be bored by means of the boring tool, which has been guided into the through-bore in the third portion of the installation device, into the component to be connected.

Preferably, a connecting element of the connecting device may in particular subsequently be brought into engagement with the first portion of the installation device, and the connecting element may be inserted into the groove by means of the installation device along the connecting direction, which in this case coincides with the direction of the central axis. In the case of the first connecting element, the previously bored hole and the passage opening in the first connecting element may be substantially aligned in an installed state.

Furthermore, the present invention provides a system for connecting a first component and a second component, in particular for connecting furniture or machine parts, which, according to the invention, comprises: one or more connecting devices, which are configured as described above and/or below, and an installation device, which is configured as described above and/or below.

Provision may be made for the system to be able to comprise at least one boring tool, in particular have a respective depth stop, as described above.

It should be understood that any structural and/or functional features and/or properties and/or advantages that are and/or have been described in conjunction with the connecting device may also be part of said system and/or may be able to be assigned thereto.

Furthermore, it should also be understood that any structural and/or functional features and/or properties and/or advantages that are and/or have been described in conjunction with the connecting device may also be part of said installation device in a corresponding and/or complementary and/or operatively connected manner and/or may be able to be assigned thereto.

Further preferred features and/or advantages of the present invention are the subject matter of the following description and the illustration of exemplary embodiments.

### BRIEF DESCRIPTION OF THE DRAWINGS

FIG. 1 shows a perspective view of a connecting device for connecting a first component and a second component, in particular for connecting furniture or machine parts, according to one exemplary embodiment of the present invention;

FIG. 2 shows a perspective view of an element of a connecting device for connecting a first component and a second component, in particular for connecting furniture or machine parts, according to a further exemplary embodiment of the present invention;

FIG. 3 shows a side view of the element in FIG. 2;

FIG. 4 shows a bottom view of the element in FIG. 2;

FIG. 5 shows a top view of the element in FIG. 2;

FIG. 6 shows an enlarged cross-sectional view of the element in FIG. 3;

FIG. 7 shows an enlarged cross-sectional view of the element in FIG. 3;

FIG. 8 shows a cross-sectional view of the element in FIG. 7;

FIG. 9 shows a perspective view of a further element of the connecting device according to the further exemplary embodiment of the present invention in FIG. 2;

FIG. 10 shows a side view of the further element in FIG. 9;

FIG. 11 shows a bottom view of the further element in FIG. 9;

FIG. 12 shows a top view of the further element in FIG. 9;

FIG. 13 shows an enlarged cross-sectional view of the further element in FIG. 10;

FIG. 14 shows a cross-sectional view of the further element in FIG. 13;

FIG. 15 shows a perspective view of a connecting device for connecting a first component and a second component, in particular for connecting furniture or machine parts, according to a further exemplary embodiment of the present invention;

FIG. 16 shows a perspective view of an installation device for a connecting device for connecting a first component and a second component, in particular for connecting furniture or machine parts, according to a further exemplary embodiment of the present invention;

FIG. 17 shows a front view of the installation device in FIG. 16;

FIG. 18 shows a top view of the installation device in FIG. 16;

FIG. 19 shows a rear view of the installation device in FIG. 16; and

FIG. 20 shows a cross-sectional view of the installation device in FIG. 19. Identical or functionally equivalent elements are provided with the same reference signs throughout the figures.

### DETAILED DESCRIPTION OF THE DRAWINGS

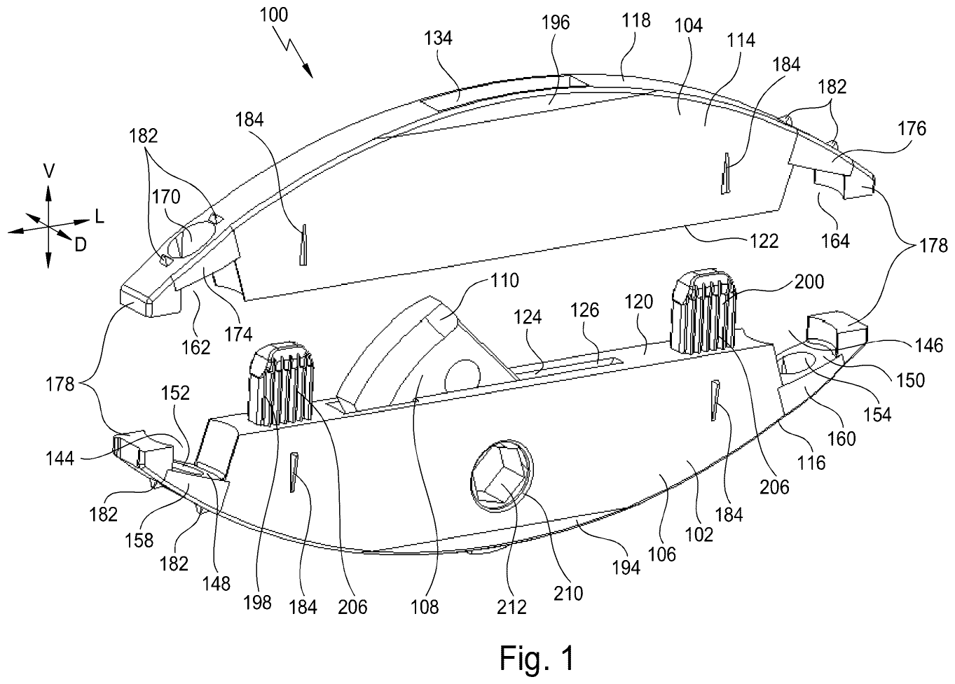

With reference to FIGS. 1 to 15, a connecting device 100 according to the invention is illustrated, which is suitable for connecting a first component and a second component.

Such components may be, in particular, furniture or machine parts.

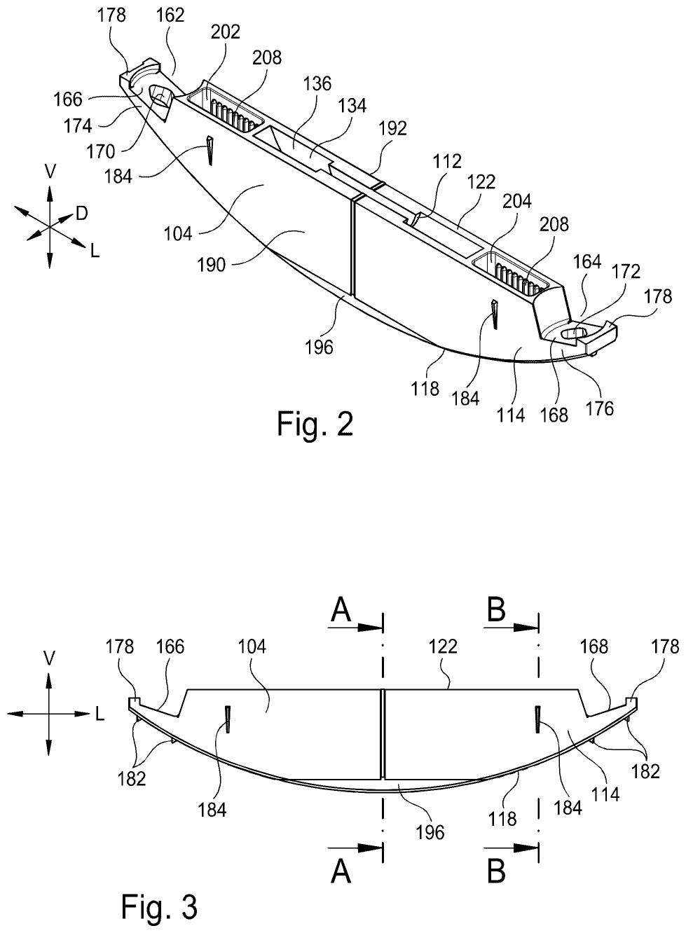

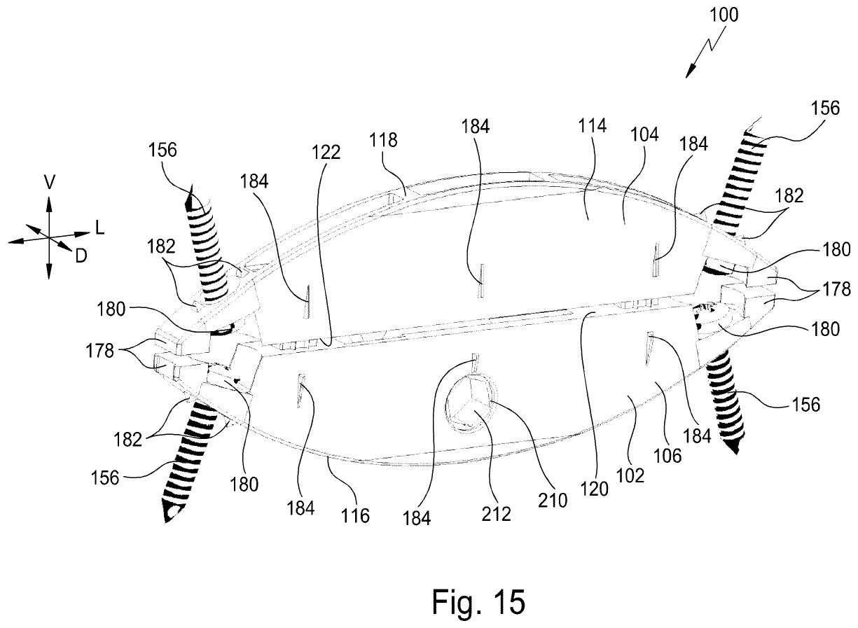

Since the connecting device 100 according to one exemplary embodiment of the present invention, which is schematically shown in FIG. 1, and the elements of the connecting device 100 according to a further exemplary embodiment of the present invention, which is schematically shown in FIGS. 2 to 14, and the connecting device 100 according to a further exemplary embodiment of the present invention, which is schematically shown in FIG. 15, are substantially identical and/or essentially the same, the three embodiments are described together in the following text for the sake of clarity, wherein, in particular, differences between these embodiments are explicitly highlighted and/or separately described.

The connecting device 100 comprises a first connecting element 102 (cf. FIGS. 9 to 14), which is able to be assigned to the first component.

In other words, the first connecting element 102 is arranged on the first component in the connected state of the components.

The connecting device 100 comprises a second connecting element 104 (cf. FIGS. 2 to 8), which is able to be assigned to the second component.

In other words, the second connecting element 104 is arranged on the second component in the connected state of the components.

The first connecting element 102 has a first housing 106 and a holding element 108, which is movable, in particular pivotable and/or rotatable, relative to the first housing 106.

The holding element 108 is configured and serves to connect the first connecting element 102 to the second connecting element 104.

It should be understood that the holding element 108 may be configured to connect the first connecting element 102 directly to the second component. It may thus be conceivable for the second connecting element 104 for connecting a first component and a second component to be able to be optional.

The movable holding element 108 has a first holding contour 110.

The second connecting element 104 has a second holding contour 112, behind which the first holding contour 110 is able to engage.

In particular, the second connecting element 104 has a second housing 114, on or in which the second holding contour 112 is arranged.

If the first connecting element 102 is intended to be directly connected to the second component, it should be understood that the second component has a second holding contour, behind which the first holding contour 110 is able to engage.

When the first holding contour 110 is engaging behind the second holding contour 112 (cf. FIG. 15), a relative movement of the first connecting element 102 and of the second connecting element 104 (and/or of the second component) along a particular direction is able to be prevented. This particular direction is a or the connecting direction V.

At least one of the connecting elements 102, 104 has, on the respective housing 106, 114, a curved face 116, 118 which is in the form of a circular arc in longitudinal section, and a substantially planar access face 120, 122, which is located opposite this curved face 116, 118 and faces the other connecting element 102, 104 in the connected state of the components.

In the present embodiments, the first connecting element 102 has a first curved face 116 and a first access face 120, which are each arranged on the first housing 106.

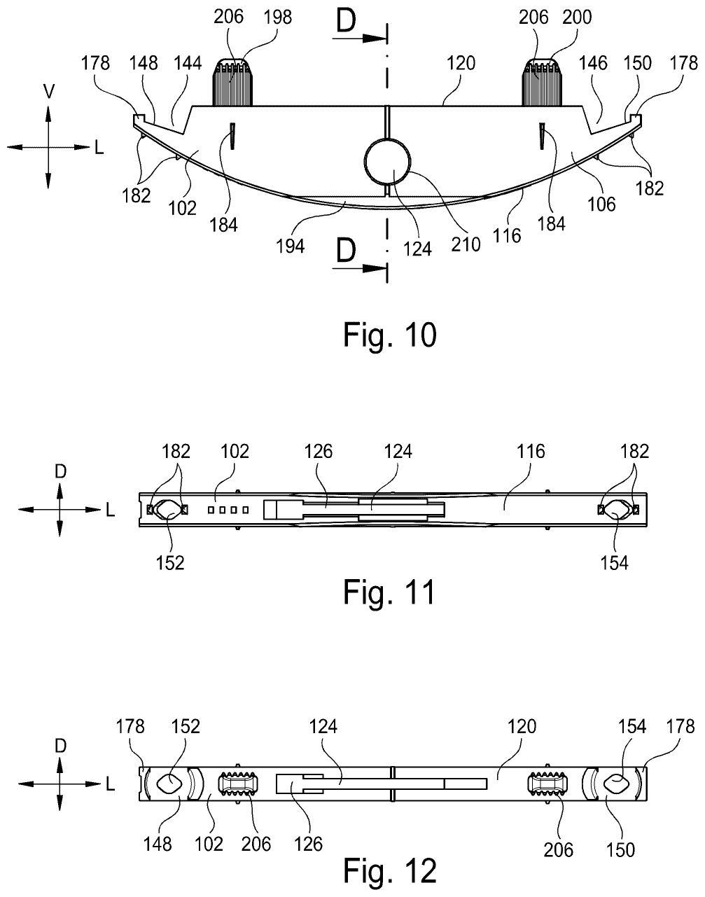

As is apparent in particular in FIGS. 10 and 14, the first curved face 116 is substantially circular in longitudinal section.

The first access face 120 is arranged opposite the first curved face 116 on the first housing 106 and is formed in a substantially planar manner.

The second connecting element 104 has a second curved face 118 and a second access face 122, which are each arranged on the second housing 114.

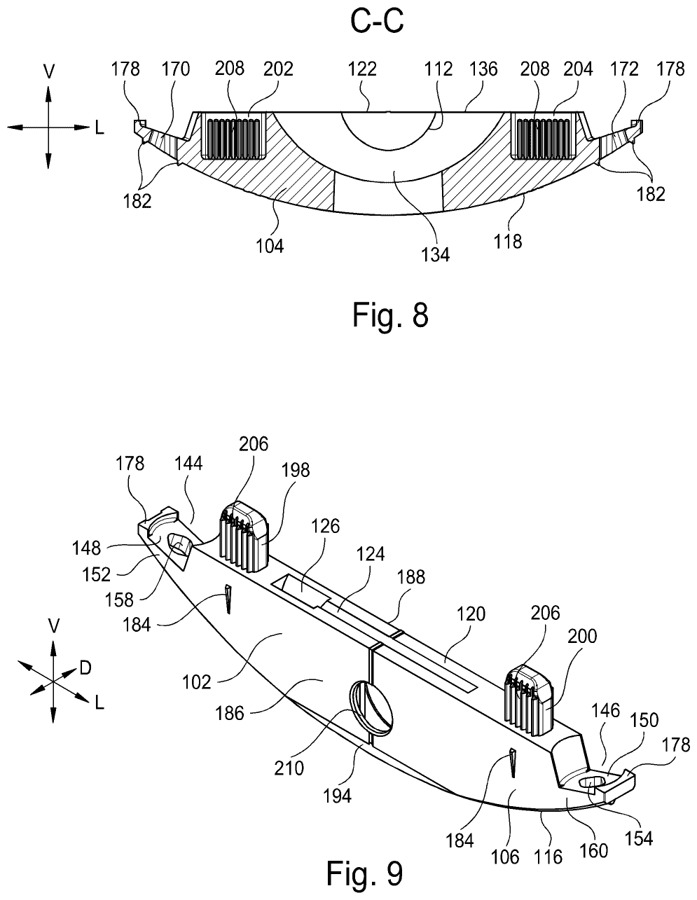

As is apparent in particular in FIGS. 3 and 8, the second curved face 118 is substantially circular in longitudinal section.

The second access face 122 is arranged opposite the second curved face 118 on the second housing 114 and is formed in a substantially planar manner.

The connecting direction V is directed transversely and, in the present exemplary embodiments, substantially perpendicularly to the respective access faces 120, 122.

A direction which is oriented substantially perpendicularly to the connecting direction V is a thickness direction D in the present case.

In particular, the holding element 108 is transversely movable and/or mobile with regard to the thickness direction D.

A direction which is oriented substantially perpendicularly to the connecting direction V and substantially perpendicularly to the thickness direction D is a longitudinal direction L in the present case.

In other words, the longitudinal direction L is oriented substantially perpendicularly to the thickness direction D and substantially parallel to or coincident with the respective substantially planar access faces 120, 122.

As is apparent from FIGS. 1 and 15, which illustrate a state which corresponds to an at least partially connected state of the components, the first and second access faces 120, 122 face one another in the connected state of the components.

The first and the second connecting element 102, 104, in particular the first and the second housing 106, 114, each extend in the thickness direction D and in the longitudinal direction L.

In other words, the first and the second connecting element 102, 104, in particular the first and the second housing 106, 114, have an extent in the thickness direction D and an extent in the longitudinal direction L.

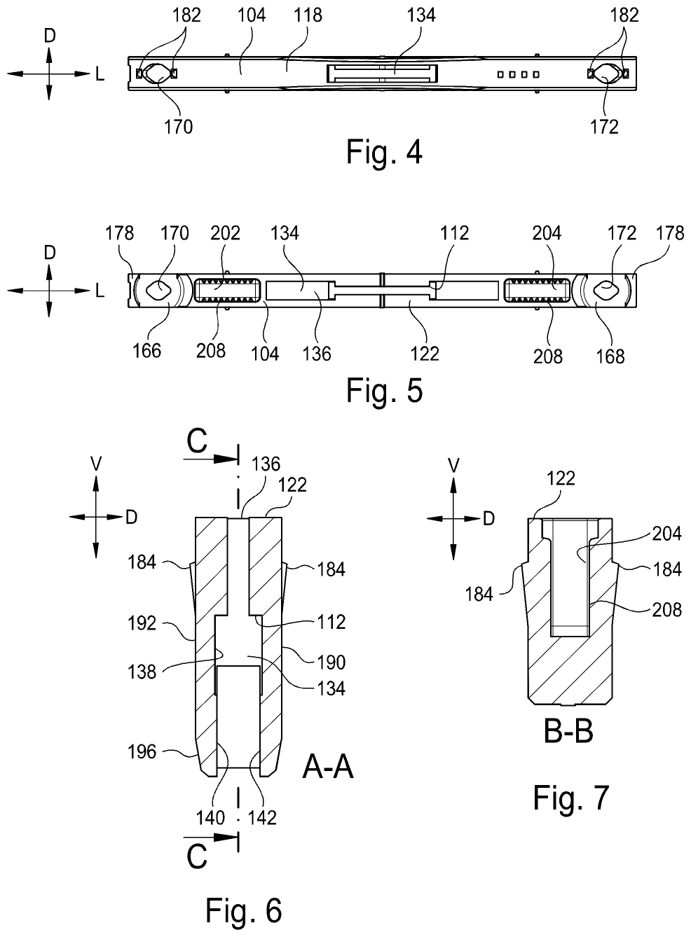

As is apparent for example from FIGS. 4, 5, 11 and 12, a ratio between the extent in the thickness direction D and the extent in the longitudinal direction L of the first and the second connecting element 102, 104, in particular the first and the second housing 106, 114, is less than or equal to 1 to 9, in particular less than or equal to 1 to 10, preferably less than or equal to 1 to 11.

In the particular embodiments in FIGS. 1 and 15, this ratio is 1 to 25±10%, whereas in the particular embodiment in FIGS. 2 to 14, this ratio is substantially 1 to 15.

For example, the ratio between the extent in the thickness direction D and the extent in the longitudinal direction L may be between substantially 1 to 9 and substantially 1 to 25, in particular between substantially 1 to 10 and substantially 1 to 25, preferably between substantially 1 to 11 and substantially 1 to 25 (optionally in conjunction with a ±10% or ±5% tolerance). It should be understood that the abovementioned ratio values can be considered as corresponding to “less than” or “less than or equal to” and/or “greater than” or “greater than or equal to”.

The ratio between the extent in the thickness direction D and the extent in the longitudinal direction L may, for example, as in the particular embodiment in FIGS. 2 to 14, be substantially 1 to 15 (optionally in conjunction with a ±10% or ±5% tolerance).

In the exemplary embodiments, the extent in the thickness direction D is substantially 4 mm±10%, in particular ±5%.

The first connecting element 102 has a first chamber 124.

The first chamber 124 is arranged in the first housing 106 and opens out at or with a first mouth opening 126 in the first access face 120.

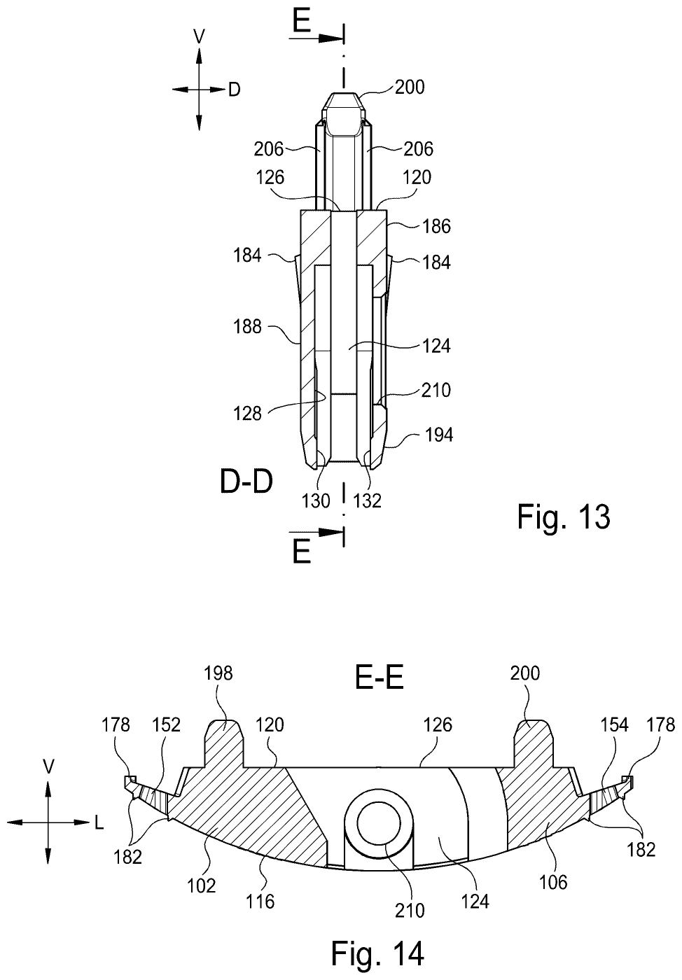

The first chamber 124 extends from the first access face 120 to the opposite side of the first housing 106 and into the first curved face 116 (cf. FIGS. 13 and 14).

With reference to FIG. 13, at least one reinforcing portion, in particular a first and a second reinforcing portion 130, 132, is provided on a side wall 128 of the first chamber 124, said reinforcing portion or portions reducing an extent of the first chamber 124, with regard to the thickness direction D, toward the first curved face 116.

The respective reinforcing portions 130, 132 are formed in a substantially stepped manner.

The respective reinforcing portions 130, 132 are respectively arranged on mutually opposite sides of the side wall 128 of the first chamber 124.

The first chamber 124 serves as a receiving space for the holding element 108 and the first holding contour 110. In other words, the holding element 108 and the first holding contour 110 are arranged in the first chamber 124. The first chamber 124 may accordingly be a receiving chamber.

As is apparent in FIG. 1, the holding element 108 is movable, in particular reversibly, out of the first chamber 124 through the first mouth opening 126, in particular in order to be able to be brought into engagement with the second holding contour 112.

The second connecting element 104 has a second chamber 134.

The second chamber 134 is arranged in the second housing 114 and opens out at or with a second mouth opening 136 in the second access face 122.

The second chamber 134 extends from the second access face 122 to the opposite side of the second housing 114 and into the second curved face 118 (cf. FIGS. 6 and 8).

With reference to FIG. 6, at least one reinforcing portion, in particular a first and a second reinforcing portion 140, 142, is arranged on a side wall 138 of the second chamber 134, said reinforcing portion or portions reducing an extent of the second chamber 134, with regard to the thickness direction D, toward the second curved face 118.

The respective reinforcing portions 140, 142 are formed in a substantially stepped manner.

The respective reinforcing portions 140, 142 are respectively arranged on mutually opposite sides of the side wall 138 of the second chamber 134.

The second chamber 134 serves as a receiving space for the second holding contour 112. In other words, the second holding contour 112 is arranged in the second chamber 134 and formed in particular integrally or in one piece (together) with the second housing 114.

The holding element 108 is movable, in particular reversibly, out of the first chamber 124 through the first mouth opening 126 and, to connect the first and the second connecting element 102, 104, is introducible, in particular reversibly, into the second chamber 134 through the second mouth opening 136, in particular in order to be able to be brought into engagement with the second holding contour 112.

With reference to FIGS. 1 and 9 to 15, the first connecting element 102 has a first and a second notch 144, 146.

The first and the second notch 144, 146 are respectively arranged, with regard to the longitudinal direction L, at or near a respectively opposite end of the first connecting element 102.

The first and the second notch 144, 146 each extend from the first access face 120 in the direction of the first curved face 116, such that, as a result, a first and a second counter face 148, 150 are defined on the first connecting element 102. In other words, the first connecting element 102, has, as a result, a or the first and a or the second counter face 148, 150.

The first and the second counter face 148, 150 are each recessed with respect to the first access face 120.

A through-hole 152, 154 in particular in the form of an oblong hole is provided in each of the counter faces 148, 150.

In other words, a first through-hole 152 in particular in the form of an oblong hole is provided in the first counter face 148 and a second through-hole 154 in particular in the form of an oblong hole is provided in the second counter face 150.

The respective through-holes 152, 154 each extend into the first curved face 116.

As is apparent from FIG. 15, the respective through-holes 152, 154 each serve to receive an anchoring element 156 for securing the first connecting element 102 to a groove bottom of a groove provided in one of the components.

A longitudinal axis of the respective through-hole 152, 154 extends substantially in a radial direction of the first curved face 116.

In particular, a first and a second fastening portion 158, 160 on the first connecting element 102 are able to be defined by the first and the second notch 144, 146.

In other words, the first connecting element 102 has a or the first and a or the second fastening portion 158, 160, which are respectively arranged, with regard to the longitudinal direction L, at or near a respectively opposite end of the first connecting element 102 and are set back in the direction of the first curved face 116 with regard to the first access face 120.

The first and the second fastening portion 158, 160 are each accordingly assigned the first and the second counter face 148, 150, which are respectively set back with respect to the first access face 120 and which are respectively assigned the first and the second through-hole 152, 154.

With reference to FIGS. 1 and 2 to 8, the second connecting element 104 has a first and a second notch 162, 164.

The first and the second notch 162, 164 are respectively arranged, with regard to the longitudinal direction L, at or near a respectively opposite end of the second connecting element 104.

The first and the second notch 162, 164 each extend from the second access face 122 in the direction of the second curved face 118, such that, as a result, a first and a second counter face 166, 168 are defined on the second connecting element 104. In other words, the second connecting element 104 has, as a result, a or the first and a or the second counter face 166, 168.

The first and the second counter face 166, 168 are each recessed with respect to the second access face 122.

A through-hole 170, 172 in particular in the form of an oblong hole is provided in each of the counter faces 166, 168.

In other words, a first through-hole 170 in particular in the form of an oblong hole is provided in the first counter face 166 and a second through-hole 172 in particular in the form of an oblong hole is provided in the second counter face 168.

The respective through-holes 170, 172 each extend into the second curved face 118.

As is apparent from FIG. 15, the respective through-holes 170, 172 each serve to receive an anchoring element 156 for securing the second connecting element 104 to a groove bottom of a groove provided in one of the components.

A longitudinal axis of the respective through-hole 170, 172 extends substantially in a radial direction of the first curved face 116.

In particular, a first and a second fastening portion 174, 176 on the second connecting element 104 are able to be defined by the first and the second notch 162, 164.

In other words, the second connecting element 104 has a or the first and a or the second fastening portion 174, 176, which are respectively arranged, with regard to the longitudinal direction L, at or near a respectively opposite end of the second connecting element 104 and are set back in the direction of the second curved face 118 with regard to the second access face 122.

The first and the second fastening portion 174, 176 are each accordingly assigned the first and the second counter face 166, 168, which are respectively set back with respect to the second access face 122 and which are respectively assigned the first and the second through-hole 170, 172.

Arranged respectively next to the respective fastening portions 158, 160, 174, 176 of the first and the second connecting element 102, 104 is an end portion 178, which defines, with regard to the longitudinal axis L, a respective end of the first and the second connecting element 102, 104. As is apparent from FIGS. 1, 3, 10 and 15, the different embodiments of the particular connecting devices 100 differ for example by way of the extent of these end portions 178 with regard to the connecting direction V. The respective end portions 178 of the embodiments in FIGS. 1 and 15 extend substantially as far as planes defined by the access faces 120, 122, and the respective end portions 178 of the embodiment in FIGS. 2 to 14 are set back with regard to those planes defined by the access faces 120, 122.

The respective through-holes 152, 154 in the first connecting element 102 narrow from the first curved face 116 in the direction of the respective counter face 148, 150 with regard to the longitudinal direction L (cf. FIG. 14), preferably substantially only with regard to the longitudinal direction L.

The longitudinal axis of the through-hole 152, 154 with respect to the connecting direction V is arranged at an angle of substantially 18°, with the result that in particular installation tolerances on introducing the anchoring elements 156 may be able to be compensated.

The respective through-holes 170, 172 in the second connecting element 104 narrow from the second curved face 118 in the direction of the respective counter face 166, 168 with regard to the longitudinal direction L (cf. FIG. 14), preferably substantially only with regard to the longitudinal direction L.

The longitudinal axis of the through-hole 170, 172 with respect to the connecting direction V is arranged at an angle of substantially 18°, with the result that in particular installation tolerances on introducing the anchoring elements 156 may be able to be compensated.

By means of the obliquely introducible anchoring elements 156 for securing the particular connecting element 102, 104 to one of the components into the through-holes 152, 154, 170, 172, an increased pull-out force is achievable when the anchoring elements 156 have been respectively introduced into and/or secured in a particular component in a connected state of the components.

As is shown in FIG. 15, the anchoring element 156 may be an anchoring screw. It is also conceivable, however, for the anchoring element to be, for example, an anchoring nail.

With reference to FIGS. 1 to 15, the respective counter faces 148, 150, 166, 168 are recessed or set back with regard to the access faces 120, 122 such that, when the respective anchoring elements 156 in the respective through-holes 152, 154, 170, 172 bear against the respective counter faces 148, 150, 166, 168 (cf., for example, FIG. 15), a head 180 of the respective anchoring element 156 does not protrude beyond the access face 120, 122 with regard to the connecting direction V and/or is arranged in particular below a plane defined by the access face 120, 122.

As is apparent in FIG. 15, the head 180 of the respective anchoring element 156 also does not project, with regard to the thickness direction D, beyond a, in particular each, lateral edge of the respective counter face 148, 150, 166, 168.

In other words, a head 180 of an anchoring element 156 is able to be received substantially entirely in one of the notches 144, 146, 162, 164.

The anchoring element 156 is thus able to be arranged on the particular connecting element 102, 104 such that its head 180 does not protrude with regard to side walls with regard to the thickness direction D and the access face 120, 122 of the particular connecting element 102, 104, or is arranged in particular within these limits.

It should be understood in the present case that the head 180 of the anchoring element 156 may relate both to a screw head and to a nail head (depending on the anchoring element 156).

With reference to FIGS. 1 to 15, one or more, in the present embodiments in each case four, in particular substantially pyramid-shaped protrusions 182 are provided on the first and the second curved face 116, 118, said protrusions protruding from the first and the second curved face 116, 118 in a direction away from the latter.

The protrusions 182 are arranged in pairs next to the through-holes 152, 154, 170, 172.

With regard to the longitudinal direction L, a protrusion 182 is arranged on each side of each of the through holes 152, 154, 170, 172.

In other words, for each through-hole 152, 154, 170, 172, two opposite protrusions 182, with regard to the through-hole 152, 154, 170, 172, are provided with regard to the longitudinal direction L.

The protrusions 182 serve for the at least partial penetration into a or the component to be connected, in order to be able to act as anti-slip means when anchoring the first and/or the second connecting element 102, 104 by means of the at least one anchoring element 156.

The first and the second connecting element 102, 104 also have a plurality of ribs 184.

In the embodiments shown in FIGS. 1 to 14, the first and the second connecting element 102, 104 each have four ribs 184, and in the embodiment shown in FIG. 15, the first and the second connecting element 102, 104 each have six ribs 184.

The ribs 184 are arranged on respective side walls 186, 188, 190, 192 of the first and of the second housing 106, 114.

The first housing 106 has a first and a second side wall 186, 188 and the second housing 114 has a first and a second side wall 190, 192, wherein the first side walls 186, 190 are respectively opposite the second side walls 188, 192.

The respective side walls 186, 188, 190, 192 extend transversely to the respective curved face 116, 118 of the respective connecting element 102, 104.

Each rib 184 extends along the particular side wall 186, 188, 190, 192 in the connecting direction V.

Furthermore, each rib 184 protrudes from the particular side wall 186, 188, 190, 192 in the thickness direction D, wherein each rib 184 protrudes toward the respective access face 120, 122 in a continuously enlarging manner with regard to the thickness direction D.

In other words, each rib 184 is formed in a substantially wedge-shaped manner, wherein its smaller end, with regard to the thickness direction, faces the respective curved face 116, 118.

As is apparent in FIGS. 3 and 10, each rib 184 has an extent that narrows with regard to the longitudinal direction L, wherein the extent relates per se to a direction from the respective access face 120, 122 toward the respective curved face 116, 118.

In other words, each rib 184 is substantially wedge-shaped with regard to the thickness direction D and to the longitudinal direction L.

The ribs 184 serve in particular as an aid, in order for it to be possible to insert the particular connecting element 102, 104 in a targeted manner into a groove which may be provided in a component to be connected.

As can be seen in particular in FIG. 13, the first housing 106 has a first portion 194 that narrows with regard to the thickness direction D.

This portion 194 is arranged, in the connecting direction V, on a side of the housing 106 that faces away from the first access face 120.

This portion 194 serves for the targeted insertion of the first connecting element 102 into a groove which is provided in the component that is able to be assigned to the first connecting element 102.

The narrowing of the portion 194 with regard to the connecting direction V is substantially 10°.

With regard to the narrowing portion 194, the first reinforcing portion 130, which is provided in the first chamber 124 of the first connecting element 102, extends in an at least partially corresponding manner from the side of the first housing 106 that faces away from the first access face 120.

The first reinforcing portion 130 extends in a substantially parallel manner along the narrowing portion 194 with regard to the connecting direction V and has an at least identical extent to or greater extent than the narrowing portion 194 in the connecting direction V.

In particular, by means of this at least partially corresponding arrangement, an in particular substantially constant wall thickness of a side wall 186, 188 of the first housing 106 may be able to be ensured, or a decrease in the wall thickness of a side wall 186, 188 of the first housing 106 may at least be able to be reduced or minimized in each case with regard to the thickness direction D.

As can be seen in particular in FIG. 6, the second housing 114 has a second portion 196 that narrows with regard to the thickness direction D.

This portion 196 is arranged, in the connecting direction V, on a side of the second housing 114 that faces away from the second access face 123.

This portion 196 serves for the targeted insertion of the second connecting element 104 into a groove which is provided in the component that is able to be assigned to the second connecting element 104.

The narrowing of the portion 196 with regard to the connecting direction V is substantially 10°.

With regard to the narrowing portion 196, the second reinforcing portion 132, which is provided in the second chamber 134 of the second connecting element 104, extends in an at least partially corresponding manner from the side of the second housing 114 that faces away from the second access face 122.

The second reinforcing portion 132 extends in a substantially parallel manner along the narrowing portion 196 with regard to the connecting direction V and has at least identical extent to or greater extent than the narrowing portion 196 in the connecting direction V.

In particular, by means of this at least partially corresponding arrangement, an in particular substantially constant wall thickness of a side wall 190, 192 of the second housing 114 may be able to be ensured, or a decrease in the wall thickness of a side wall 190, 192 of the second housing 114 may at least be able to be reduced or minimized in each case with regard to the thickness direction D.

With reference to FIGS. 1 to 15, the first connecting element 102 has a first and a second plug-in protrusion 198, 200, which are arranged on the first access face 120 on opposite sides of the first mouth opening 126 with regard to the longitudinal direction L, and protrude from the first access face 120.

The second connecting element 104 has a first and a second receiving pocket 202, 204, which are formed in a substantially complementary manner to the first and the second plug-in protrusion 198, 200.

The first and the second receiving pocket 202, 204 are arranged in the second access face 122 on opposite sides of the second mouth opening 136 with regard to the longitudinal direction L, and are recessed into the second housing 114 from the second access face 122.

In the connected state of the connecting elements 102, 104 or of the components, the first receiving pocket 202 receives the first plug-in protrusion 198 and the second receiving pocket 204 receives the second plug-in protrusion 200.

As a result, it is possible, for example by means of the connection between the connecting elements 102, 104, for shear forces to be removed and/or it is possible to dispense with additional plugs, as may be necessary in most other connecting devices.

The first and the second plug-in protrusion 198, 200 are provided laterally with a plurality of ribs and/or grooves, which define a rib-groove region 206.

The ribs and/or grooves extend substantially along the connecting direction V.

The first and the second receiving pocket 202, 204 are likewise provided laterally with a plurality of grooves and/or ribs, which correspond to the plurality of ribs and/or grooves of the plug-in protrusions 198, 200 and accordingly define a corresponding groove-rib region 208.

The respective ribs and/or grooves, or the corresponding regions 206, 208, are configured to be able to be brought into mutual engagement with one another and to be (brought) in(to) mutual engagement in particular in the connected state of the components.

As is apparent in particular from FIGS. 1 to 15, each plug-in protrusion 198, 200 and/or each receiving pocket 202, 204 of the connecting elements 102, 104 is correspondingly assigned a rib 184 on the respective side wall 186, 188, 190, 192 of the respective housing 106, 114 and is oriented in a correspondingly aligned manner along the connecting direction V.

As described above, the holding element 108 is configured and serves to connect the first connecting element 102 to the second connecting element 104.

In particular, the holding element 108 is movable from a holding position into a release position and/or from the release position into the holding position by means of a mechanical actuating device that is able to be brought into engagement with the holding element 108 from outside the connecting element 102.

In the release position, the holding element 108 is received substantially entirely in the first chamber 124, and in the holding position, the holding element 108 is received at least partially in the second chamber 134 in order to make it possible to engage the first holding contour 110 behind the second holding contour 112.

In other words, in the holding position, the first holding contour 110 engages at least partially behind the second holding contour 112, and in the release position, the first holding contour 110 does not engage behind the second holding contour 112.

In order for the holding element 108 to be actuable, the first housing 106 of the first connecting element 102 is provided with a passage opening 210 for the passage of a mechanical actuating device to the holding element 108.

In other words, in order to allow the mechanical actuating device to act on the holding element 108, the first housing 106 of the first connecting element 102 comprises a or the passage opening 210 for the passage of the mechanical actuating device to the holding element 108.

As is apparent in FIGS. 1 and 15, the holding element 108 has a polygonal key receptacle 212, in order to be actuable by means of the mechanical actuating device in the form of a polygonal key. Other receptacles and/or mechanical actuating devices are likewise conceivable.

Preferably, the connection of the two connecting elements 102, 104 is able to be brought about by a relative movement of the holding element 108 relative to the first housing 106 of the first connecting element 102 from the release position into the holding position. Furthermore, the connection between the connecting elements 102, 104 is releasable again by a movement of the holding element 108 relative to the first housing 106 of the first connecting element 102 from the holding position into the release position.

Preferably, the connecting elements 102, 104 are lockable together by the movement of the holding element 108 into the holding position, such that, as a result of tensile forces that act on the connecting elements 102, 104 in the connecting direction V, the components to be connected are able to be braced with one another, with the result that a completely firm connection between the components to be connected is able to be established.

With reference to the embodiment shown in FIG. 15, the first and the second housing 106, 114 each have two notches in their curved faces 116, 118. This may serve in particular to save material and to make the connecting elements 102, 104 lighter.

The connecting device 100 and/or in particular each of its connecting elements 102, 104 is/are respectively configured to cooperate with an installation device 300, or this installation device 300 is configured to cooperate with the connecting device 100 and/or in particular with each of its connecting elements 102, 104, and is configured to cooperate with the components to be connected.

Accordingly, the present invention provides an or the installation device 300 for a connecting device 100 for connecting a first component and a second component, in particular for connecting furniture or machine parts.

In the present case, this connecting device 100 is the connecting device 100 described in conjunction with FIGS. 1 to 15.

The installation device according to the invention comprises a main body 302, which extends substantially along a central axis Z.

The main body 302 is formed at least partially in a complementary and/or corresponding manner to the connecting device 100 in order to be able to be brought into in particular form-and/or force-fitting engagement therewith (with the connecting device 100) and/or to be insertable into a groove which is provided in one of the components to be connected for the at least partial insertion of the connecting device 100.

By means of this installation device 300, it may in particular be possible for at least one processing step to be able to be carried out by means of the installation device 300 on one of the components to be connected in preparation for installation of the connecting device 100 therein, and/or for the connecting device 100 itself to be able to be at least partially installed by means of the installation device 300 in at least one of the components to be connected.

The main body 302 has a first, a second and a third portion 304, 306, 308.

The first portion 304 is formed at least partially in a complementary manner to the first part of the connecting device 100 in order to be able to be brought into in particular form- and/or force-fitting engagement with this part.

The second portion 306 is formed at least partially in a corresponding manner to a second part of the connecting device 100 in order to be insertable into a groove which is provided in one of the components to be connected for the at least partial insertion of the connecting device 100, in particular for the substantially complete insertion of the second part of the connecting device 100.

The first portion 304 is arranged at a first end of the main body 302 with regard to the central axis Z.

The third portion 308 is arranged at a second end of the main body 302 with regard to the central axis Z.

The second portion 306 is arranged, with regard to the central axis Z, between the first and the third portion 304, 308.

The main body 302 has a center marking 310 which indicates a central mirror plane of the main body 302 and which is arranged in the first portion 304.

The center marking 310 is in the form of at least one indentation, in the present case four indentations that are aligned with one another with regard to the central axis Z.

The first portion 304 is formed at least partially in a complementary manner to one side of the first and of the second connecting element 102, 104 of the connecting device 100, wherein that side faces the respective access face 120, 122 of the particular connecting element 102, 104 of the connecting device 100.

In other words, the first portion 304 is formed at least partially in a complementary manner both to that side of the first connecting element 102 that faces the first access face 120 and to that side of the second connecting element 104 that faces the second access face 122.

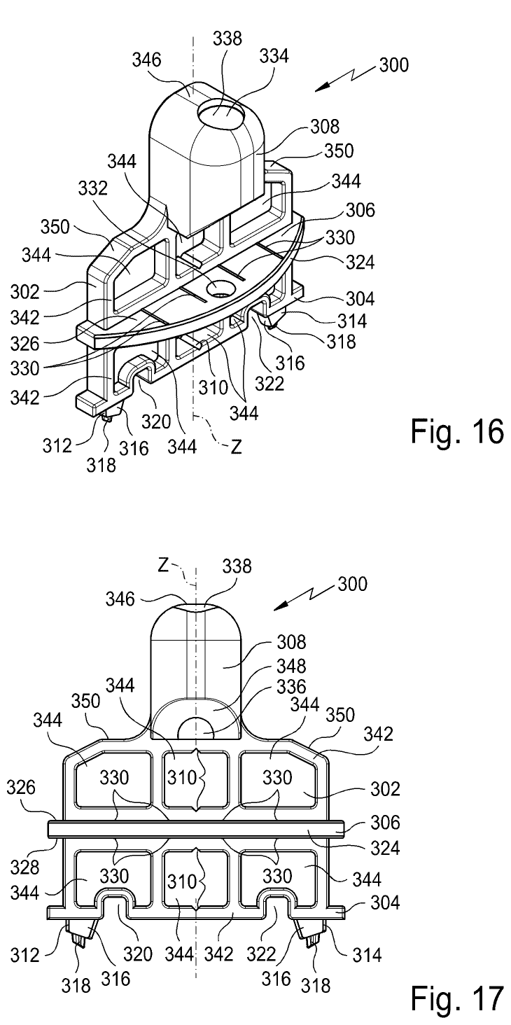

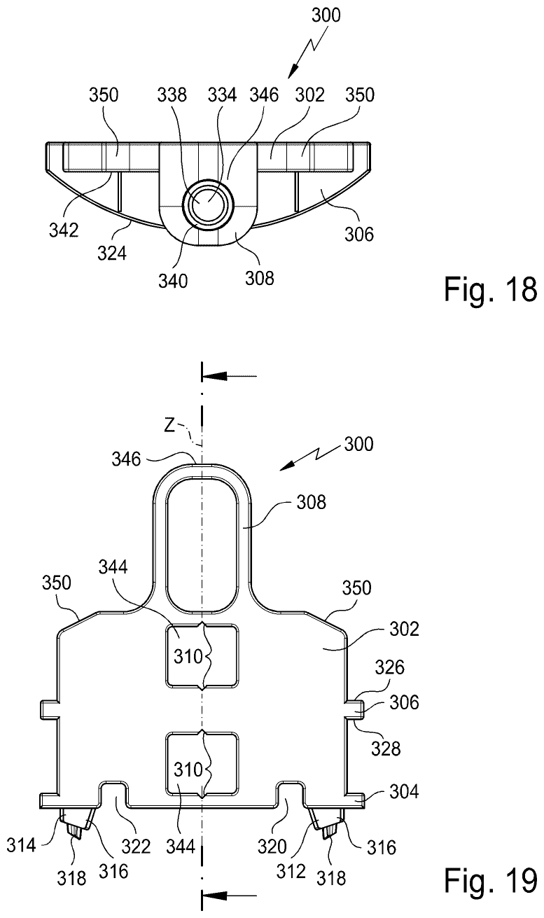

As is apparent in particular in FIGS. 16 and 17, the first portion 304 has a first and a second protrusion 312, 314.

The first and the second protrusion 312, 314 each protrude substantially in the direction of the central axis Z.

The first and the second protrusion 312, 314 each have a protrusion base 316 and an engagement portion 318, wherein the engagement portion 318 extends away from the protrusion base 316 in the direction of the main body 302.

The protrusion bases 316 are formed in a substantially complementary manner to the notches 144, 146, 162, 164 in the first and the second connecting element 102, 104, in order to be able to be brought into in particular form-and/or force-fitting engagement therewith.

The engagement portions 318 are formed in a substantially complementary manner to the through-holes 152, 154, 170, 172 in particular in the form of oblong holes in the first and the second connecting element 102, 104, in order to be able to be brought into in particular form-and/or force-fitting engagement therewith.

In other words, the first and the second protrusion 312, 314 are able to be brought into in particular form-and/or force-fitting engagement with the first and the second connecting element 102, 104 of the connecting device 100, in particular with the through-holes 152, 154, 170, 172 thereof, which are provided in the particular connecting element 102, 104 of the connecting device 100.

Furthermore, the first portion 303 has a first and a second notch 320, 322 for receiving the first and the second plug-in protrusion 198, 200 of the first connecting element 102.

The first portion 304 serves in particular to be able to be brought into engagement with the first and/or the second connecting element 102, 104, in order for it to be possible to insert the particular connecting element 102, 104, in a manner plugged onto and/or coupled to the installation device 300, in particular purely translationally into a groove in a component to be connected, in the direction of the central axis Z and/or of the connecting direction V, which in this case coincide.

The second portion 306 extends substantially perpendicularly to the central axis Z.

The second portion 306 has a curved face 324, which is in the form of a circular arc in longitudinal section and faces away from the main body 300.

The second portion 306 is formed in a manner substantially corresponding to the first and the second connecting element 102, 104 of the connecting device 100.

In particular, the second portion 306 corresponds substantially to an external contour of the first housing 106 of the first connecting element 102 of the connecting device 100 and/or to the external contour of the second housing 114 of the second connecting element 104 of the connecting device 100.

The second portion 306 accordingly has preferably a ratio between an extent in the direction of the central axis Z and an extent, perpendicular thereto, along the main body 302 of less than or equal to 1 to 9, in particular less than or equal to 1 to 10, preferably less than or equal to 1 to 11.

For example, this ratio may be between 1 to 9 and 1 to 25, in particular between 1 to 10 and 1 to 25, preferably between 1 to 11 and 1 to 25. It should be understood that the abovementioned ratio values can be considered as corresponding to “less than” or “less than or equal to” and/or “greater than” or “greater than or equal to”.

The ratio may be, for example, substantially 1 to 15.

The second portion 306 has, in the direction of the central axis Z, a first, in particular upper side wall, and an opposite second, in particular lower side wall 326, 328.

Each of the side walls 326, 328 is provided with a plurality of ribs, in particular compression ribs 330.

Each of the compression ribs 330 protrudes substantially in the direction of the central axis Z starting from the respective side wall 326, 328; this means substantially downward or substantially upward.

Preferably, a thickness tolerance and/or a thickness difference of the groove into which the installation device 300 is at least partially insertable and which is provided in one of the components to be connected for the at least partial insertion of the connecting device 100 may be able to be compensated by means of the compression ribs 330 when the installation device 300 has been at least partially inserted into the groove.

The second portion 306 also has a first through-bore 332.

The first through-bore 332 extends from the upper side wall 326 to the lower side wall 328.

The first through-bore 332 in the second portion 306 is arranged in a manner corresponding to the passage opening 210 in the first housing 106 of the first connecting element 102, said passage opening serving for the passage of the mechanical actuating device to the holding element 108.

The third portion 308 has a second through-bore 334.

The second through-bore 334 serves for receiving and/or passing through a boring tool (not shown in the figures).

In the second through-bore 334 in the third portion 308, at least one boring bush 340 is arranged and/or able to be arranged, with the result that in particular the lifetime of the installation device 300 may be extendable.

The second through-bore 334 extends in the direction of the central axis Z and/or substantially perpendicularly to the second portion 306.

The second through-bore 334 has a mouth opening 336, which faces the second portion 306, and a further mouth opening 338, which faces the second portion 306.

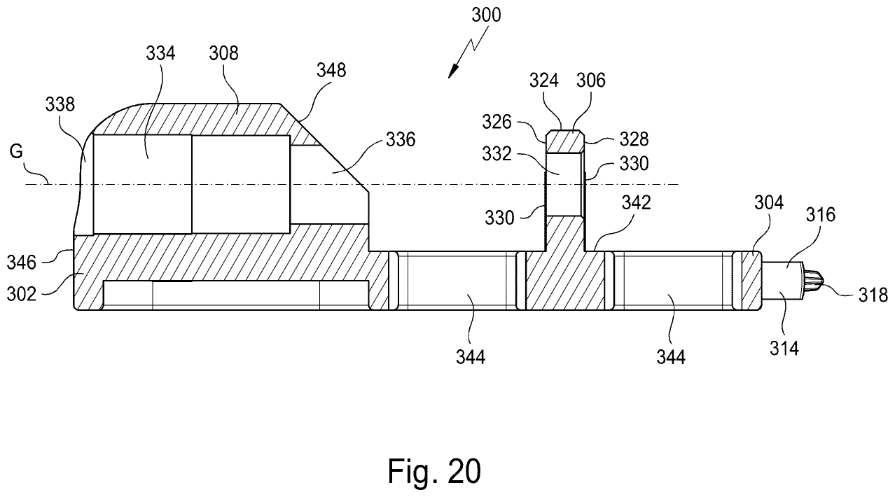

The second through-bore 334 in the third portion 308 and the first through-bore 332 in the second portion 306 extend respectively along an axis, these forming a common axis G on account of the substantially aligned arrangement of the through-bores 332, 334 with one another, as can be seen in FIG. 20.

The common axis G is oriented substantially parallel to the central axis Z.

The first through-bore 332 in the second portion 306 is furthermore configured to at least partially receive the boring tool.

In other words, the through-bores 332, 334 are arranged with respect to one another such that the boring tool is able to be passed through the second through-bore 334 first and, after bridging a distance between the third and the second portion 308, 306, is introducible into the first through-bore 332 in order for the boring tool to be at least partially received therein.

The boring tool is guided and/or guidable in the through-bores 332, 334 along the common axis G thereof.

In particular, the common axis G of the second through-bore 334 in the third portion 308 and the first through-bore 332 in the second portion 306 is arranged at a defined position with regard to a component to be connected, when the second portion 306 of the installation device 300 has been inserted into the groove which is provided in the components to be connected for the at least partial insertion of the connecting device 100.

A longitudinal axis of the passage opening 210 for the passage of the mechanical actuating device to the holding element 108 is arranged at this defined position with regard to the particular component, when the first connecting element 102 of the connecting device 100 has been inserted substantially completely into this groove.

In other words, by means of the boring tool in conjunction with the installation device 300, a bore is able to be realized in a component to be connected, said bore being arranged and/or able to be arranged at that position that substantially corresponds to that position at which the passage opening 210 in the first connecting element 102 is correspondingly arranged and/or able to be arranged when the first connecting element 102 has been inserted into said groove.

The main body 302 furthermore comprises at least one substantially planar stop face 342 for placing in a substantially flush manner against one of the components to be connected.

From the stop face 342, the second portion 306 extends substantially perpendicularly to the central axis Z.

In other words, the stop face 342 extends substantially perpendicularly to the second portion 306.

Arranged in the stop face 342 are a plurality of recesses 344 (in the present case six recesses 344).

Some of the plurality recesses 344 are arranged above the second portion 306 with regard to the central axis Z (in the present case three recesses 344), and some of the plurality of recesses 344 are arranged below the second portion 306 with regard to the central axis Z (in the present case three recesses 344).

The recesses 344 serve in particular to receive material, for example chips, separated by means of a machining step, for example boring by means of the boring tool, out of one of the components to be connected.

In other words, the recesses 344 serve for example as a chip reservoir.

As can be seen in FIG. 19, some of the recesses 344 extend through the entire main body 302 and the rest of the recesses 344 extend at least partially through the latter.

In other words, each of the recesses 344 extends from the stop face 342 in the direction of a side of the main body 302 that faces away from the second portion 306, wherein in particular at least some of the recesses 344 pass in particular entirely through the main body 302 substantially in this direction.

As can be seen in particular in FIGS. 16 and 19, the third portion 308 is provided with a further stop face 346, which faces away from the main body 302 in the direction of the central axis Z and which serves for the abutment of a depth stop which is attached and/or able to be attached to the boring tool for defined boring into a component to be connected.

Furthermore, the third portion 308 is provided with a substantially planar face that is oblique with respect to the central axis Z, in other words a substantially planar oblique face 348 which faces the second portion 306.

The oblique face 348 encloses an angle with the substantially planar stop face 342.

In the present case, the angle is 45°. Other angle values may likewise be conceivable, for example 15°, 30°, 60° or 75°.

The main body also has one or more pulse receiving faces 350 (in the present case two pulse receiving faces).

The pulse receiving faces 350 are arranged respectively between the third and the second portion 308, 306.

The pulse receiving faces 350 serve to receive pulses, for example hammer strikes, in order to achieve orientation of the installation device 300 in conjunction with a component to be connected and/or to allow and/or force insertion of a connecting element 102, 104 coupled to the installation device 300 into a component to be connected.

Each of the pulse receiving faces 350 is oriented at least partially and/or substantially entirely in the direction of the central axis Z.

Each of the pulse receiving faces 350 has a surface portion to which the central axis Z is substantially perpendicular, and has a further surface portion which is at an angle to the first surface portion.

In the present case, the angle is 30°. Other angle values may likewise be conceivable, for example 15°, 45°, 60° or 75°.

Preferably, after the groove has been introduced into the component to be connected, the second portion 306 of the installation device 300 can be inserted into this groove.

Subsequently, a hole can be drilled in the component to be connected by means of the boring tool, which is guided or able to be guided in the through-bore 334 in the third portion 308 of the installation device 300.

Preferably, a connecting element 102, 104 of the connecting device 100 can subsequently be brought into engagement with the first portion 304 of the installation device 300.

This connecting element 102, 104 can be inserted into the groove, by means of the installation device 300, along the connecting direction V, which in this case coincides with the direction of the central axis Z.

In the case of the first connecting element 102, the previously bored hole and the passage opening 210 in the first connecting element 102 may be substantially aligned in an installed state.

Subsequently, the holding element 108 may be actuable, through that hole and the passage opening 210 via the polygonal key receptacle 212, by means of the mechanical actuating device in order to connect the first and second connecting elements 102, 104 or the components to be connected.

### LIST OF REFERENCE SIGNS

100 Connecting device
102 First connecting element
104 Second connecting element
106 First housing
108 Holding element
110 First holding contour
112 Second holding contour
114 Second housing
116 First curved face
118 Second curved face
120 First access face
122 Second access face
124 First chamber
126 First mouth opening
128 Side wall
130 First reinforcing portion
132 Second reinforcing portion
134 Second chamber
136 Second mouth opening
138 Side wall
140 First reinforcing portion
142 Second reinforcing portion
144 First notch
146 Second notch
148 First counter face
150 Second counter face
152 First through-hole
154 Second through-hole
156 Anchoring element
158 First fastening portion
160 Second fastening portion
162 First notch
164 Second notch
166 First counter face
168 Second counter face
170 First through-hole
172 Second through-hole
174 First fastening portion
176 Second fastening portion
178 End portion
180 Head of anchoring element
182 Protrusion
184 Rib
186 First side wall
188 Second side wall
190 First side wall
192 Second side wall
194 First narrowing portion
196 Second narrowing portion
198 First plug-in protrusion
200 Second plug-in protrusion
202 First receiving pocket
204 Second receiving pocket
206 Rib-groove region
208 Groove-rib region
210 Passage opening
212 Polygonal key receptacle
300 Installation device
302 Main body
304 First portion
306 Second portion
308 Third portion
310 Center marking
312 First protrusion
314 Second protrusion
316 Protrusion base
318 Engagement portion
320 First notch
322 Second notch
324 Curved face
326 First or upper side wall
328 Second or lower side wall
330 Compression rib
332 First through-bore
334 Second through-bore
336 Mouth opening
338 Further mouth opening
340 Boring bush
342 Stop face
344 Recess
346 Further stop face
348 Oblique face
350 Pulse receiving face
D Thickness direction
G Common axis
L Longitudinal direction
V Connecting direction
Z Central axis

1. A connecting device for connecting a first component and a second component or for connecting furniture or machine parts, the connecting device comprising:
a first connecting element arranged on the first component in the connected state of the components; and/or
a second connecting element arranged on the second component in the connected state of the components,
wherein the first connecting element comprises a first housing and a holding element, which is movable relative to the first housing of the first connecting element, for releasably connecting the first connecting element to the second connecting element and/or to the second component,
wherein the movable holding element comprises a first holding contour,
wherein the second connecting element and/or the second component comprises a second holding contour behind which the first holding contour is able to engage,
wherein at least one of the connecting elements comprises, on the respective housing, a curved face, which is in the form of a circular arc in longitudinal section, and a substantially planar access face, which is located opposite this curved face and faces the other connecting element in the connected state of the components,
wherein at least one of the connecting elements extends in a thickness direction and in a longitudinal direction, wherein the thickness direction is oriented substantially perpendicularly to a connecting direction which is directed transversely, or substantially perpendicularly, to the access face, and wherein the longitudinal direction is oriented substantially perpendicularly to the thickness direction and substantially parallel to or coincident with the substantially planar access face.

2. The connecting device as claimed in claim 1, wherein a ratio between the extent in the thickness direction and the extent in the longitudinal direction is less than or equal to 1 to 9, or less than or equal to 1 to 10, or less than or equal to 1 to 11.

3. The connecting device as claimed in claim 1, wherein at least one of the connecting elements has a chamber which is arranged in the respective housing and which opens out at a mouth opening in the access face and extends, on the opposite side, into the curved face, wherein, on a side wall of the chamber, at least one reinforcing portion is provided, which reduces an extent of the chamber, with regard to the thickness direction, toward the curved face.

4. The connecting device as claimed in claim 1, wherein at least one of the connecting elements has at least one notch which extends from the access face in the direction of the curved face such that the respective connecting element also has a counter face that is recessed with respect to the access face, wherein a through-hole, or a through-hole in the form of an oblong hole, is provided in the counter face, said through-hole extending into the curved face and serving to receive an anchoring element for securing the respective connecting element to a groove bottom of a groove provided in one of the components, and/or wherein a longitudinal axis of the through-hole extends substantially in a radial direction of the curved face.

5. The connecting device as claimed in claim 1, wherein at least one of the connecting elements has a first and a second notch which are respectively arranged, with regard to the longitudinal direction, at or near a respectively opposite end of the respective connecting element and which respectively extend from the access face in the direction of the curved face such that the respective connecting element also has a first and a second counter face which are respectively recessed with respect to the access face, wherein a through-hole, or a through-hole in the form of an oblong hole, is provided in each of the counter faces, said through-hole respectively extending into the curved face and respectively serving to receive an anchoring element for securing the respective connecting element to a groove bottom of a groove provided in one of the components, and/or wherein a longitudinal axis of the respective through-hole extends substantially in a radial direction of the curved face.

6. The connecting device as claimed in claim 4, wherein the respective connecting element is provided or able to be provided, in each through-hole, with an anchoring element, or an anchoring element in the form of an anchoring screw, for securing the respective connecting element to one of the components.

7. The connecting device as claimed in claim 1, wherein the housing of at least one of the connecting elements has a portion that narrows with regard to the thickness direction, said portion being arranged, in the connecting direction, on a side of the housing that faces away from the access face, and serving for the targeted insertion of the respective connecting element into a groove which is provided in the component that is able to be assigned to the connecting element, and/or wherein this narrowing with regard to the connecting direction is between 5° and 15°, or between 7.5° and 12.5°, or substantially 10°.

8. The connecting device as claimed in claim 1, wherein one or more protrusions, or one or more substantially conical or substantially pyramid-shaped protrusions, are provided on the curved face, said protrusions protruding from the curved face in a direction away from the curved face.

9. The connecting device as claimed in claim 1, wherein at least one of the connecting elements has one or more ribs which are provided on a side wall of the respective housing, said side wall extending transversely to the curved face of the respective connecting element, wherein the one or more ribs on the side wall extend along the connecting direction and protrude toward the access face from the side wall in an enlarging manner with regard to the thickness direction, or in a continuously enlarging manner with regard to the thickness direction.

10. The connecting device as claimed in claim 1, wherein one of the connecting elements has at least one supporting element and the other of the connecting elements has at least one mating element that is formed in an at least partially complementary manner thereto, the at least one supporting element and the at least one mating element being engaged with one another in the connected state of the components, wherein the at least one supporting element is arranged on the access face of the one connecting element and forms a part of a side wall of the housing of the one connecting element, and/or wherein the at least one supporting element is in the form of a supporting protrusion and the associated mating element is in the form of a supporting recess and/or supporting-element receptacle, and/or wherein the at least one supporting element has a substantially convex shape starting from the access face.

11. The connecting device as claimed in claim 1, wherein at least one of the connecting elements comprises at least one plug-in protrusion and the respectively other connecting element comprises at least one receiving pocket that receives the plug-in protrusion in the connected state of the components.

12. The connecting device as claimed in claim 1, wherein the holding element is movable from a holding position into a release position and/or from the release position into the holding position by means of a mechanical actuating device that is able to be brought into engagement with the holding element from outside the connecting element, wherein, in the holding position, the first holding contour at least partially engages behind the second holding contour, and in the release position, the first holding contour does not engage behind the second holding contour.

13. The connecting device as claimed in claim 1, wherein the housing of the first connecting element is provided with a passage opening for the passage of a mechanical actuating device to the holding element.

14. The connecting device as claimed in claim 1, wherein at least one of the connecting elements is insertable, or insertable purely translationally, substantially along the connecting direction into a groove which is provided in the component that is able to be assigned to the connecting element.

15. An installation device for said connecting device for connecting said first component and said second component or for connecting said furniture or said machine parts, as claimed in claim 1, the installation device comprising:
a main body, which extends substantially along a central axis,
wherein the main body is formed at least partially in a complementary and/or corresponding manner to the connecting device in order to be able to be brought into engagement therewith, or into form-and/or force-fitting engagement therewith, and/or to be insertable into a groove which is provided in one of the components to be connected for the at least partial insertion of the connecting device.

16. The installation device as claimed in claim 15, wherein the main body has a first and a second portion, wherein the first portion is formed at least partially in a complementary manner to a first part of the connecting device in order to be able to be brought into engagement with said first part, or into form-and/or force-fitting engagement with said first part, and wherein the second portion is formed at least partially in a corresponding manner to a second part of the connecting device in order to be insertable into a groove which is provided in one of the components to be connected for the at least partial insertion of the connecting device, or for the substantially complete insertion of the second part of the connecting device.

17. The installation device as claimed in claim 16, wherein the first portion is arranged at a first end of the main body with regard to the central axis and is formed at least partially in a complementary manner to a side of the at least one of the connecting elements of the connecting device, said side being faced by the access face of the respective connecting element of the connecting device.

18. The installation device as claimed in claim 16, wherein the first portion has at least one protrusion which protrudes substantially in the direction of the central axis and which is able to be brought into engagement with at least one of the connecting elements of the connecting device, or into form-and/or force-fitting engagement with at least one of the connecting elements of the connecting device, and/or with a through-hole, or a through-hole in the form of an oblong hole, the through hole being provided in the respective connecting element of the connecting device.

19. The installation device as claimed in claim 16, wherein the first portion has at least one notch in which at least one plug-in protrusion of one of the connecting elements of the connecting device is able to be received, or in which at least one plug-in protrusion of one of the connecting elements of the connecting device is able to be received when the installation device is engaged with the connecting device.

20. The installation device as claimed in claim 16, wherein the second portion extends substantially perpendicularly to the central axis and has a curved face which is in the form of a circular arc in longitudinal section and faces away from the main body, and/or wherein the second portion is formed in a manner substantially corresponding to at least one of the connecting elements of the connecting device and/or the second portion has a ratio between an extent in the direction of the central axis and an extent perpendicular thereto along the main body of less than or equal to 1 to 9, or less than or equal to 1 to 10, or less than or equal to 1 to 11.

21. The installation device as claimed in claim 16, wherein the main body has at least one substantially planar stop face for placing in a substantially flush manner against one of the components to be connected, from which the second portion extends substantially perpendicularly to the central axis.

22. The installation device as claimed in claim 16, wherein the main body has a third portion in which a through-bore for receiving and/or passing through a boring tool is provided, wherein the through-bore extends in the direction of the central axis and/or substantially perpendicularly to the second portion, and the one mouth opening thereof faces the second portion, and/or wherein at least one boring bush is arranged or able to be arranged in the through-opening.

23. The installation device as claimed in claim 22, wherein the first portion is arranged at a first end of the main body and the third portion is arranged at a second end of the main body with regard to the central axis, and/or wherein the second portion is arranged between the first and the third portion with regard to the central axis.

24. A system for connecting a first component and a second component or for connecting furniture or machine parts, the system comprising:
one or more connecting devices; and
an installation device;
wherein the one or more connecting devices each are a connecting device for connecting said first component and said second component, or for connecting said furniture or said machine parts, comprising:
a first connecting element arranged on the first component in the connected state of the components; and/or
a second connecting element arranged on the second component in the connected state of the components,
wherein the first connecting element comprises a first housing and a holding element, which is movable relative to the first housing of the first connecting element, for releasably connecting the first connecting element to the second connecting element and/or to the second component,
wherein the movable holding element comprises a first holding contour,
wherein the second connecting element and/or the second component comprises a second holding contour behind which the first holding contour is able to engage,
wherein at least one of the connecting elements comprises, on the respective housing, a curved face, which is in the form of a circular arc in longitudinal section, and a substantially planar access face, which is located opposite this curved face and faces the other connecting element in the connected state of the components,
wherein at least one of the connecting elements extends in a thickness direction and in a longitudinal direction, wherein the thickness direction is oriented substantially perpendicularly to a connecting direction which is directed transversely, or substantially perpendicularly, to the access face, and
wherein the longitudinal direction is oriented substantially perpendicularly to the thickness direction and substantially parallel to or coincident with the substantially planar access face;
wherein the installation device comprises a main body, which extends substantially along a central axis,
wherein the main body is formed at least partially in a complementary and/or corresponding manner to the connecting device in order to be able to be brought into engagement therewith, or into form-and/or force-fitting engagement therewith, and/or to be insertable into a groove which is provided in one of the components to be connected for the at least partial insertion of the connecting device.
